(19) United States
(12) Patent Application Publication
(10) Pub. No.: US 2010/0211462 A1
(43) Pub. Date: Aug. 19, 2010

(54) Targeted Content on a Product Distribution Network

(76) Inventor: David Nowacek, San Antonio, TX (US)

Correspondence Address: JACKSON WALKER, L.L.P., 112 E. PECAN, SUITE 2400, SAN ANTONIO, TX, 78205, US

(21) Appl. No.: 12/706,692

(22) Filed: Feb. 16, 2010

Related U.S. Application Data
(60) Provisional application No. 61/152,861, filed on Feb. 16, 2009.

(51) Int. Cl. A63F 9/24; G06Q 50/00; G06Q 30/00

(52) U.S. Cl. 705/14.52; 463/42; 463/35; 463/22; 463/29

(57) ABSTRACT

A method and system for providing targeted content over a product distribution network (PDN) is disclosed. A PDN is capable of receiving product request messages (PRMs), such as messages sent by short messaging service (SMS). A user who sends a PRM receives a response message, including the requested data, an advertisement, and a virtual game piece, which potentially alters the user's status in the game. Under some conditions, the user wins a prize, which may be targeted to the user's demographic data. In some embodiments, to complete a game, or to redeem a prize, the user will need to visit a website.

### CROSS REFERENCE TO RELATED APPLICATIONS

This application claims priority to U.S. Provisional Application 61/152,861 entitled “Targeted Content on a Product Distribution Network,” filed Feb. 16, 2009, which is incorporated herein by reference. This application also incorporates by reference the following: U.S. application Ser. No. 12/244,571, entitled “Playlist on Demand,” filed Oct. 2, 2008; U.S. application Ser. No. 12/295,831, entitled “Product Distribution Network,” filed Oct. 2, 2008; PCT application PCT/US08/63433, entitled “Product Distribution Network,” filed May 12, 2008; U.S. provisional application 60/928,810, entitled “A Method for Queuing and Retrieving Remote Content via Short Message Service,” filed May 11, 2007; and U.S. provisional application 61/021,715, entitled “Product Distribution Network,” filed Jan. 17, 2008.

### BACKGROUND

This specification relates to the field of wireless communications, and more particularly to a method of providing and playing games over wireless communication networks.

Wireless communication networks, and particularly mobile telephone networks, facilitate near-real-time communication. Such networks are useful for providing a product distribution network (PDN), such as the one disclosed in the parent application. Also disclosed in the parent application is a method of adding songs to an online playlist by selecting them over a PDN.

### BRIEF DESCRIPTION OF THE DRAWINGS

FIG. 1 is a network diagram disclosing an exemplary embodiment of a PDN providing targeted content;

FIG. 1A is a diagram of selected elements of FIG. 1 showing a response message in more detail;

FIG. 2 is a block diagram of an embodiment of a game server that may be operated by a PDN provider;

FIG. 3 is a front view of an embodiment of a mobile device for use with a PDN;

FIG. 3A is a second view of the mobile device of FIG. 3;

FIG. 3B is a third view of the mobile device of FIG. 3;

FIG. 4 is a flow chart showing logic for operating an embodiment of a Five-Card Draw game; and

FIG. 5 is a flow chart showing logic for operating an embodiment of a secret playlist game.

### SUMMARY OF THE INVENTION

In one aspect, A method and system for providing targeted content over a product distribution network (PDN) is disclosed. A PDN is capable of receiving product request messages (PRMs), such as messages sent by short messaging service (SMS). A user who sends a PRM receives a response message, including the requested data, an advertisement, and a virtual game piece, which potentially alters the user's status in the game. Under some conditions, the user wins a prize, which may be targeted to the user's demographic data. In some embodiments, to complete a game, or to redeem a prize, the user will need to visit a website.

### DETAILED DESCRIPTION OF THE EMBODIMENTS

Targeted data, and in particular data that are relevant to end users' demographic, are valuable to both the end users and the distributors. By targeting advertisements, distributors use their advertising dollars most efficiently by advertising to audiences most likely to be interested in their products. End users, who are generally consumers, benefit by being introduced to products they are likely to find useful or desirable.

A product distribution network (PDN) can be a valuable medium for providing targeted content to end users. A PDN's value is further enhanced in direct proportion to users' interaction with it. The present specification discloses a network and method useful for increasing the value of a PDN as a medium for delivering targeted content and for encouraging increased user interaction.

In one aspect, a PDN as disclosed includes a website or other user interface where users can sign up for an account with the PDN provider. The website may permit a user to sign up for an account by providing both required and optional information. In some cases, the required information will be only that information minimally necessary to create and operate a user account. Because some users are sensitive about providing too much information, optional data fields can be provided, and users can fill out as many or as few as they want. Both the required and optional registration data can be a valuable source of demographic data about the user. For example, users may optionally be permitted to provide such information as their employment status, interests, hobbies, and even religious or political preferences.

Any or all of these demographic data can be useful in selecting a subgroup of a population and providing that subgroup with targeted content that may be of interest to it. For example, users “Mary” and “Tom” may both live in the Anytown, USA market. “Sally” may operate “Scrappin' Sally's Crafts and Scrapbooking Store,” and “Joe” may operate “Joe's Tavern,” both potential advertisers in the Anytown market. In this fictional example, Mary is 36 years old, female, married, Mormon, a full-time homemaker, a mother of four children, and interested in scrap booking. Mary may be part of a demographically-defined subgroup more likely to respond to advertisements and promotional offers from Scrappin' Sally's. On the other hand, Tom is 24 years old, male, single, agnostic, a full-time student, and majoring in art. Tom may be part of a demographically-defined subgroup more likely to respond to special offers from Joe's Tavern. One objective of the present invention is to increase the likelihood that Mary will get Sally's advertisement and that Tom will get Joe's advertisement, thus providing each user with content he or she is likely to be interested in, and helping each advertiser reach its best target audiences.

Providing targeted content to end users makes a PDN a valuable resource for communicating opportunities. That value is further enhanced as users are incentivized to increase interaction with the PDN. One method of increasing user interaction is to provide contests or games, which add value by providing rewards, which can be tailored to the user based on demographic data or other user-specific data.

In one exemplary embodiment of the present disclosure, “Mary” and “Tom” both open accounts with a PDN provider and provide information on numerous preferences. The PDN provider may provide a service such as the radio metadata service disclosed in the applications referenced above. In addition, the PDN provider may operate a number of games in conjunction with the PDN, and include in the signup process a setting wherein the user selects a preferred game. In this example, Mary selects the “Secret Playlist” game, and Tom selects the “Five-Card Draw” game. If a PRM is received from a number not associated with a registered user, then a game piece for a default game may be included.

In the Secret Playlist game, the PDN maintains a secret list, possibly containing between one and five songs. The secret playlist may be a single universal list applicable to all users of the PDN, or it may be specific to a particular radio station, family of radio stations, or geographic market, and the secret playlist may be cycled at certain intervals. Mary listens to radio station WPTO at 99.5 MHz in Anytown, which uses the nickname “FRESH 99.5.” Mary may hear a song on that station that she is unfamiliar with or that she wants to add to her online playlist. She “tags” the song by sending a product request message (PRM) to the PDN provider, for example by sending a short messaging service (SMS) message to a particular number owned by the PDN provider. The text of the message may be a station identifier such as “WPTO,” “99.5,” “995,” “FRESH,” or variations thereof. Note that, while the call letters of the radio station may be unique, the frequency and nickname may be used in more than one location. Thus, the PDN provider may need to determine that Mary is listening to “FRESH” in Anytown rather than “FRESH” in Othertown, USA. This information may be based on Mary's area code or may be determining, for example, the location of the cell tower that received Mary's call. Furthermore, while the example disclosed here relates to so-called “terrestrial radio,” which is usually broadcast locally, a product distribution would also be suitable for use with other broadcast technologies, such as television, satellite radio, or internet radio. In that case, unique identification information may be required.

Upon receiving the PRM and uniquely identifying the station, the PDN provider may query a metadata provider to determine that the song “Methods” by the group “Better than Bilski” was playing on WPTO when Mary sent the message. “Methods” is added to Mary's online playlist, and the PDN also checks to see if “Methods” is on the Secret Playlist. If it is, Mary may win a prize. The PDN provider may query Mary's demographic data and correlate the data to a database of available advertisements and/or prizes. Based on Mary's demographic data, the PDN provider may send Mary a response message indicating that she has tagged a song on the Secret Playlist, and has won a coupon for 10% off of her next purchase of $20 or more at Sally's. If “Methods” is not on the Secret Playlist, the response message may include other targeted content, such as a targeted advertisement, or a “consolation prize” of lesser value, such as a coupon for a free candy bar with the purchase of a soft drink at a local convenience store. Mary may redeem these prizes in one of several ways. She may be able to show the messaging device itself to the proprietor of a business, or she may be able to login to a game server and print a coupon, which may include a bar code or other common device for identifying the coupon. After Mary has used the coupon, Sally's may destroy it if a paper copy, or delete it from Mary's messaging device if electronic. In some cases, the value of a repeat customer may be greater to Sally's than the value of the coupon, and Sally may choose to let Mary keep the coupon on her messaging device. If the prize is particularly valuable, and the proprietor is concerned about Mary keeping a copy on her messaging device, a unique code may be assigned to the prize so that it can only be redeemed once.

As Mary continues to play the Secret Playlist song, she may receive increasingly valuable prizes if, for example, she tags multiple songs on the Secret Playlist, or tags all of the songs in the correct order. For example, by tagging one song, Mary may receive a 10% discount and be entered into a drawing for a grand prize. If Mary tags two of five songs, she may receive a $5 gift certificate, and receive a second entry into the grand prize drawing. If Mary tags three of the five songs, she may receive a $10 gift certificate, and so on. If Mary is the first to tag all five songs in the correct order, she may instantly win a cash prize. In an alternative, Mary may be notified when she has tagged all five songs on the secret playlist, and may then be able to login to a game server and guess the correct order to try for a more valuable prize.

In the Five-Card Draw game, Tom may receive a “card” for each song that he tags for his playlist. Cards are drawn from a virtual 52-card non-replaced deck containing the standard suits and ranks. Because PRMs and response messages may be in text-only format, a simple text code can identify each card. For example, 10D may represent the 10 of diamonds, QS may represent the queen of spades, and so on. Other messaging protocols may provide richer content, in which case the card may be graphically represented. After Tom tags five songs, he has a full hand. He may then log on to a game server operated by the PDN provider and may have the opportunity to discard and draw new cards. Once Tom has completed his hand, he may be awarded a prize commensurate with the hand he holds. For example, the following hands are listed in increasing order of value, according to their standard definitions: No pair high card, one pair, two pair, three of a kind, straight, flush, full house, four of a kind, straight flush, royal flush. The value of prizes may be inversely (though not necessarily linearly) proportional to, the probability of the user's hand. If, after completing his hand, Tom holds only two of a kind, he may win a minimal prize such as a free coffee at a local convenience store. If instead, he holds a royal flush, he may win a large prize, such as $1,000. In another variation, a poker engine representing the “house” on the game server may also receive a hand from the same deck, and Tom may try to beat the house. In yet another variation, Tom may identify a group of friends to play against. Once each player has completed his hand, the player with the highest hand will win a prize. This option would facilitate increasing social interaction through the PDN.

As a third exemplary game, a “Lotto” may be provided. The Lotto may assign a user an alphanumeric string each time he or she tags a song. The user's number will then be entered into a drawing for a prize. Drawings may be held at regularly-scheduled intervals. When a user wins a Lotto game, the PDN provider may notify the user with a response message, and the information necessary to redeem the prize may be provided in the response message, or the user may be required to login to the game server.

Although three specific games have been disclosed above, many other games can be formulated for play over a PDN. Because of the limitless possibility of different games, another value-added feature may include an interface through which users can design their own games for use on the PDN. This may take the form of a simple graphical drag-and-drop type interface, wherein the user may select a type of game piece, and winning conditions based on the value of one or more game pieces. The probability of each winning condition may be calculated automatically, and prizes awarded for each winning condition may be awarded on a scale inversely proportional to the probability of the condition. In order to maximize the flexibility of designing PDN games, in addition to or instead of the drag-and-drop interface, users may be enabled to submit games programmed in a commonly-known scripting language such as JavaScript, Tcl, or Perl. In that case, the PDN provider may specify certain common data structures representing game pieces and winning conditions and then allow end users to define game play in the scripting language. As the PDN provider accumulates a catalog of games authored by users, it may provide a portal allowing end users to try games created by other end users, and may provide additional incentives for authors of popular games.

As an alternative to the prizes disclosed in the above examples, the PDN could also provide a “points” system, which would allow users to accumulate points by playing games, and then trade points for sponsored promotions in an online store. For example, Mary may receive 2 points for correctly identifying a song on the playlist, or Tom may win 2 points for a pair. In the online store, Mary may be able to purchase a coupon for 10% off at her favorite craft store for 5 points, or Tom may be able to purchase a coupon for a free cup of coffee at a convenience store for the same amount. Advantageously, this provides highly-targeted content, as the content is user selected, and further encourages additional interaction with the network.

The disclosed PDN may also interact with advertisers. For example, advertisers may receive separate “advertising accounts” with the PDN provider. The advertising account would allow an advertiser to log on to a game server, select preferred demographics it would like to advertise to, and purchase a number of targeted advertisements. For example, Sally may log onto the game server. Based on the location of her store, she may select desirable zip codes in Anytown, and may also select desirable metadata attributes. For example, Sally may choose to advertise to the zip code where her store is located, as well as three surrounding zip codes. She may also decide to advertise to women who are 18 and older and who indicated a preference for crafts, art, scrapbooking, or stamping. She then may then enter a customized advertisement or promotional offer up to a certain number of characters and purchase a group of 500 messages at a certain cost per message. On the other hand, Joe may choose to advertise to zip codes near a local university, and may choose to advertise to men 21 and older who are college students or who indicate a preference for social eating and drinking and sports.

This method of selecting a target demographic described above may be described as a “Boolean AND” operation. A user will match only if each of the criteria (zip code is one of the four selected zip codes, female, 18+, and a preference in at least one of crafts, art, scrapbooking, or stamping) is matched to a preferred demographic field. Each field will either exactly match the preferred demographic field or not. For example, in the example above, Sally's advertisement would not be delivered to “Jim,” a 19-year old male with an expressed preference for crafts or “Jane,” a 23-year-old female with preferences for crafts, scrapbooking, and stamping who lives in a different zip code. In some cases, this may be the desired result. But in other cases, an advertiser may want to provide more flexible criteria.

In some embodiments, an advertiser may be able to use a weighted analysis by assigning each field a value, for example, on a scale of 1 to 10, rather than using metadata fields as exclusive qualifiers. Sally may select a number of metadata fields and score each one for importance by assigning it a weight factor. For example, Sally may select the fields “Gender: Female,” “Marital Status: Married,” “Age: 18+,” “Employment: Homemaker,” “Hobbies: Crafts,” “Hobbies: Art,” “Hobbies: Scrapbooking,” “Hobbies: Stamping,” “Zip: 12345,” “Zip: 12346,” and “Zip: 12347.” She may decide that she has almost no men customers, and select “Female” as an exclusive requirement. She may then decide that her most important attributes otherwise are “Scrapbooking,” “Stamping,” and “12345,” and assign each of these a number between 8 and 10, indicating that these factors together strongly identify a potential client. She may decide that “Crafts,” “18+,” “Married,” “Homemaker,” and “123456” are slightly less important, and assign each a number between 5 and 7. Finally, she may decide that, though useful, “Art,” and “12347” are the weakest indicators of a potential client, and assign these a number between 2 and 4. Sally may also want to select certain fields to exclude or to assign a negative score. For example, Sally may determine from past experience that accountants, college professors, liberal feminists, and those in zip code 12349 are less likely to be customers. With only 500 messages, Sally may not want to expend many messages on users who are unlikely to be interested. So she may assign some of those attributes a negative score from −1 to −10, and may use others as absolute exclusions. With both positive and negative factors assigned, a computer may then assign each user in a certain population a score based on Sally's criteria. Those with multiple strong positive attributes will receive higher scores and those with the highest scores may be targeted to receive Sally's advertisement.

Although providing metadata, games, and targeted content as described above has value in each part, a synergistic effect may be achieved by combining all three into one response message. In particular, the PDN provider may choose not to charge users any up-front cost for using the service. This encourages prolific use of the service, as users will want the metadata and will want to continue playing games to increase their chances of receiving a valuable prize. The value of a response message as an advertising or promotional medium varies directly with the number of messages sent. Because users are encouraged to send many PRMs, they will receive many targeted advertisements and promotional offers. This may make the response message an attractive enough medium for advertisers that the service can be supported entirely by advertisements. Furthermore, games may have aspects that encourage users to interact with a network-connected user interface such as a website operated by the PDN provider or a standalone application with online capabilities. This provides further opportunities to provide valuable advertisements. Each increase of activity helps to ensure that advertisers can reach their most likely customers and that users receive offers that are relevant and interesting to them.

The method disclosed above provides significant advantages, particularly to smaller businesses that normally would not be able to afford traditional radio advertising. This method gives those smaller businesses access to targeted subsets of large radio-listening populations, thereby giving them enhanced value for their advertising dollars. The PDN also provides advertisers with a tenable method of using text-messages for advertisement. In particular, text message advertisements cannot be used until a user has opted in. But even after an initial opt-in, users may become annoyed if the advertiser continues to send unsolicited text message advertisements. Because the PDN allows the user to opt in each time a message is sent, the advertisements may be perceived as less intrusive, and thus the advertiser is not likely to be associated with “spamming” customers. As a further inducement to advertisers, the advertiser may be able to purchase a quantity of messages at a fixed rate, with a guaranteed delivery within a fixed time. If the PDN provider is unable to deliver all of the purchased messages within the time (for example, because there are not enough PRMs), a pro rata refund may be provided to the advertiser, so that the advertiser can be confident that he is paying only for advertisements that are actually sent.

The PDN provides advantages for radio station operators as well. Recent research indicates that radio listeners tend to change stations en masse when stations break from playing music to playing commercials. This tends to decrease the value of air time commercials for radio advertisers, thus creating financial difficulties for the station operators. The PDN provides a method for the music itself to become a vehicle for valuable, targeted advertisements, which can be marketed to advertisers. This may also provide a competitive advantage, as radio stations participating in a PDN may finally be able to make good on claims of playing “more music” than the competition with adversely affecting their revenues. Finally, the PDN allows station operators to monetize even their competitors play time. Since a radio station has no proprietary right in the mere fact that it plays a certain song at a certain time, an operator who partners with a PDN provider may be able to sell advertisements that are sent out in response to users who tag songs played by the competition.

The PDN also provides advantages for local and startup musicians, who may be primarily interested in increasing their exposure. For example, local musicians whose fan base is not large enough to warrant air time on centrally-programmed radio stations may offer digital recordings of their songs as prizes to users of PDN games. This gives the local bands exposure that they otherwise could not achieve. In another embodiment, a band playing a local venue could provide placards at each table with a list of songs to be played that night. Each song could be accompanies by an alphanumeric code. A user can then tag a song he hears at the concert by finding the code on the placard and sending it to the PDN provider as the body of a PRM. The song could then be added to the user's online playlist, or the user could be offered a free or discounted download of the song.

Providing targeted content on a product distribution network will now be described with more particular reference to the attached drawings. Hereafter, details are set forth by way of example to facilitate discussion of the disclosed subject matter. It should be apparent to a person of ordinary skill in the field, however, that the disclosed embodiments are exemplary and not exhaustive of all possible embodiments.

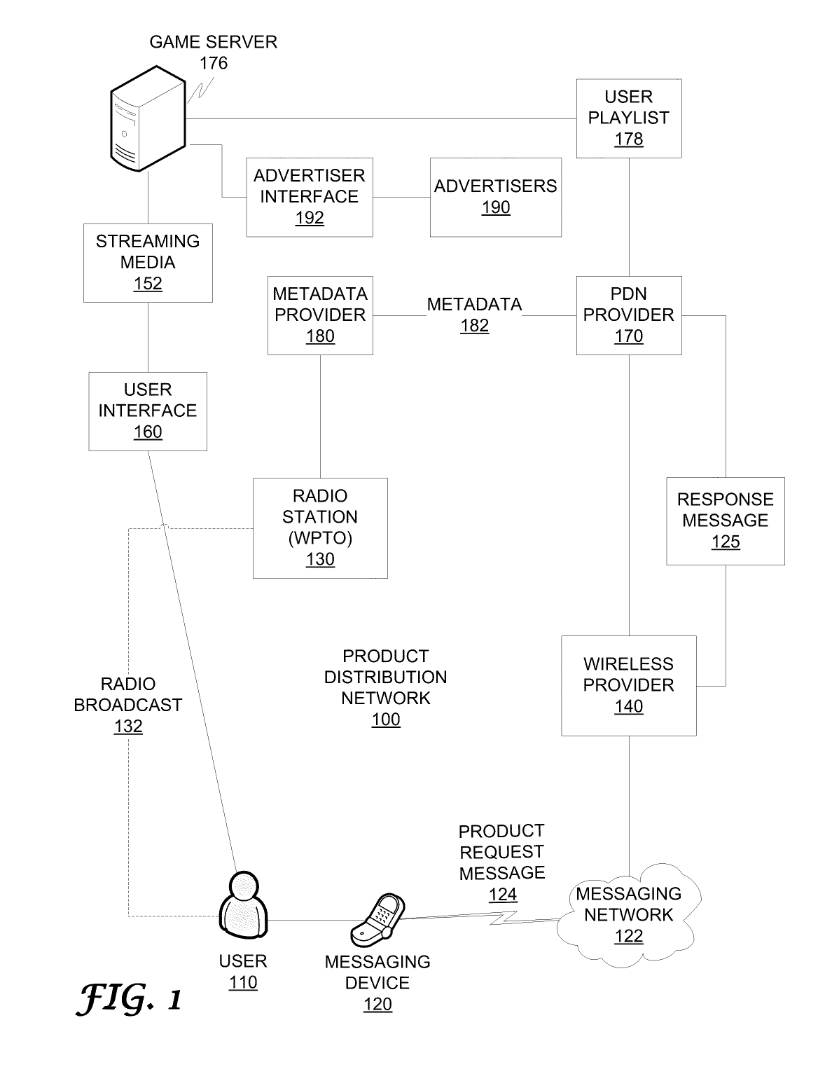

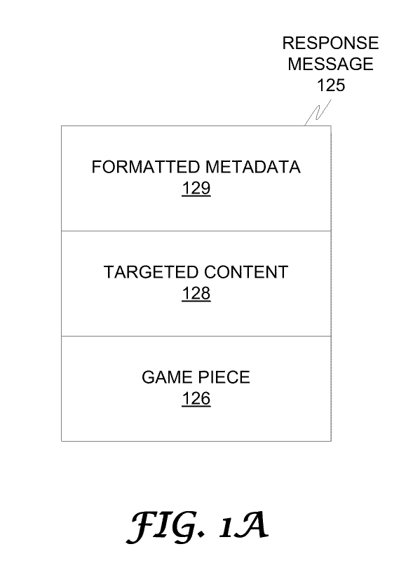

FIGS. 1 and 1A disclose, by way of non-limiting example, an embodiment of a PDN 100 providing targeted content. In this embodiment, user 110 is listening to radio broadcast 132, provided by radio station 130. User 110 hears a song on radio station 130 and wants to know what song she is hearing and/or add the song to her playlist. User 110 operates messaging device 120 to send a PRM 124 through messaging network 122, to wireless provider 140, which delivers the message to PDN provider 170. This process is known as “tagging” the song. PDN provider 170 may operate a game server 176, which, as depicted, automatically handles functions for PDN provider 170. Depending on the scale and complexity of PDN 100, game server 176 may be anything from a single computer or the equivalent to an extensive network of server and support equipment. In some embodiments, PRM 124 includes a time stamp and textual information identifying radio station 130. Game server 176 may query metadata provider 180 and receive metadata 182 identifying the song that radio station 130 was playing when user 110 sent PRM 124. Metadata provider 180 may be, for example, a radio monitoring service such as Media Guide®, which independently monitors numerous radio stations. Game server 176 may then add the requested song to user playlist 178, which may be accessible by user 110 via user interface 160, which in some cases may be accessible on a personal computer, and which may be either a local or networked application capable of receiving streaming media. When user 110 wants to hear songs in her playlist, she may operate user interface 160, which is provided with streaming media 152 from user playlist 178 provided by PDN provider 170. PDN provider 170 may also cause advertisements 162 to be sent to user interface 160.

After user 110 tags the song, game server 176 generates a game piece 126, which in some cases, such as the Secret Playlist game, is dependent on the song tagged, while in other cases, such as Five-Card Draw and Lotto, is independent of the song tagged. Game piece 126 contains information that changes the user's 110 status in the game. For example, in the Secret Playlist game, the game piece 126 may indicate whether or not the user has selected a song on the Secret Playlist. In the Five-Card Draw game, the game piece 126 may represent a card added to user's 110 hand. In the Lotto game, the game piece 126 may include a lotto number. It is anticipated that game server 176 will also store information about the game piece, though this is not required in all situations.

Game server 176 may then send a response message 125 to user 110, who sees it on messaging device 120. As seen in FIG. 1A, a response message 125 may consist of formatted metadata 129, targeted content 128, and a game piece 126. In some cases, the ordering of these parts of the message may be crucial to a successful commercial game operation. For example, in some cases, a substantial portion of revenue may be derived from advertisements associated with targeted content 128. If targeted content 128 is ordered last, it may scroll off the visible portion of the screen of messaging device 120. In that case, users may not bother to scroll down, and so the advertising value may be lost. On the other hand, the users' primary reason for sending PRM 124 may be to find out what songs they are hearing. If targeted content 128 appears first in the message, it may be seen as merely an annoyance standing in the way of useful information. So in some embodiments, it may be advantageous to place the elements of response message 125 in the order depicted in FIG. 1A. Specifically, formatted metadata 129 appears first, targeted content 128 appears second, and game piece 126 appears last. With this arrangement, users will immediately see the requested information, formatted metadata 129. But because formatted metadata 129 may take as little as one or two lines in some cases, there will be ample room for an eye-catching portion of targeted content 128 to be immediately visible. Many users will also be interested in seeing their game pieces 126, which provides an incentive to scroll down past the targeted content 128. In some cases where a user wins a prize, targeted content 128 will be incorporated into the prize. For example, the prize may be a discount coupon or similar item that serves as an incentive to visit an advertiser 190. In that case, it may be advantageous to change the order and place the targeted content 128 after game piece 126.

Advertisers 190 may also be able to interact with game server 176 through advertiser interface 192. In particular, advertisers may receive a separate “advertising account” with PDN provider 170. The advertising account would allow an advertiser to log on to advertiser interface 192, select demographics it would like to advertise to, enter text for an advertising message or promotional offer, and purchase a number of targeted advertisements.

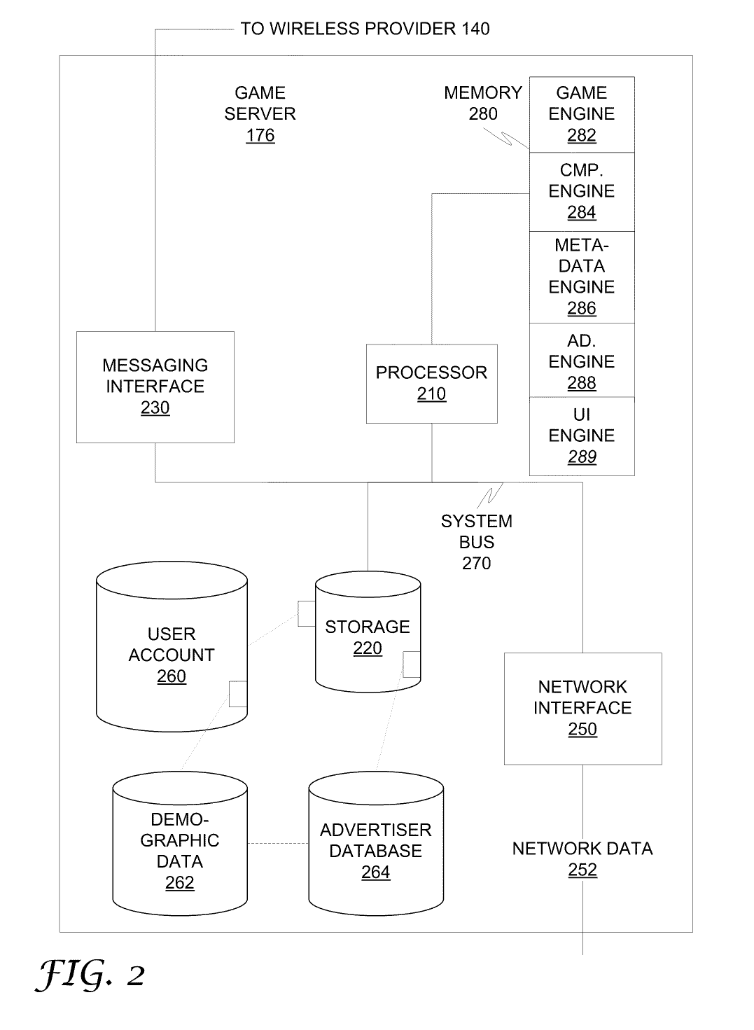

FIG. 2 is a block diagram of a game server 176 that may be operated by PDN provider 170. In this embodiment, a processor 210 is communicatively coupled to other parts of the system through a system bus 270. Included in the system is a messaging interface 230 that connects game server 176 to wireless provider 140, enabling the game server to receive PRMs 124 and send response messages 125. Game server 176 also includes a storage medium 220, which may be populated with a user account database 260, wherein each user account includes demographic data 262. There is also an advertiser database 264, which includes records for a number of advertisers, wherein the records may include fields such as an advertisement or promotional offer and preferred demographic data characterizing a subgroup of the population to which the advertisement or promotional offer should be directed. Game server 176 is then connected to network services through network interface 250 which handles network data 252. It should be noted that the interconnections shown are logical and not representative of physical arrangements. For example, user account database 260 and content database 264 could reside on wholly separate physical machines from each other and from processor 210 without affecting their logical function. In some embodiments, network interface 250 will be the means by which game server 176 connects to metadata provider 180, license provider 150, and user interface 160, while messaging interface 230 is the means by which game server 176 connects to wireless provider 140. In some embodiments, the messaging network and data network may be a common network, or may communicate on a common protocol, in which case messaging interface 230 and network interface 250 may be a single physical device.

In some embodiments, storage 220 may be a hard disk or other equivalent storage medium 110. Specifically, storage 220 may contain software instructions that, when executed, instruct processor 210 to receive a PRM 124 from user 110, generate a game piece 126 in response to PRM 124, and provide a response message 125 to user 110. The response message may include a combination of metadata 129, targeted content 128, and game piece 126, and in one exemplary embodiment includes all three.

Memory 280 may be connected directly to processor 210 or may be connected through a bus such as system bus 270. Memory 280 generally represents a low-latency medium such as dynamic random-access memory (DRAM) where applications may be placed for execution. In some cases, applications will be permanently stored in storage 220 and then temporarily copied to memory 280 for execution, while in other embodiments, storage 220 and memory 280 may be a single physical device. As shown, memory 280 may include, among others, the following applications: a game engine 282, a comparison engine 284, a metadata engine 286, and an advertising engine 288. Game engine 282 includes instructions that, when executed, provide a game as described herein. Comparison engine 284 includes instructions that, when executed, provide comparison functions for matching user demographic data 262 to preferred demographic data specified by advertisers in advertiser database 264, and as described above, may rely on any comparison method, including a Boolean AND method and a weighted comparison. Metadata engine 286 includes instructions that, when executed, perform the functions of querying metadata provider 180 for metadata and formatting responses for delivery in a response message 125. Advertising engine 288 includes instructions that, when executed, provide advertiser interface 192. User interface engine 289 includes instructions that, when executed, provide user interface 160.

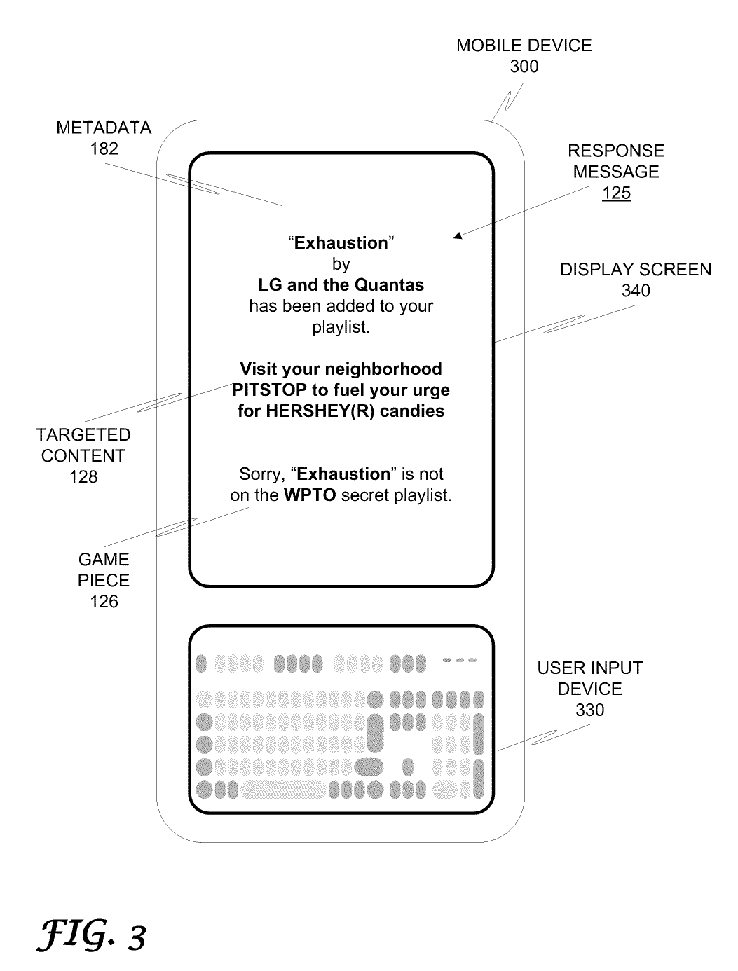

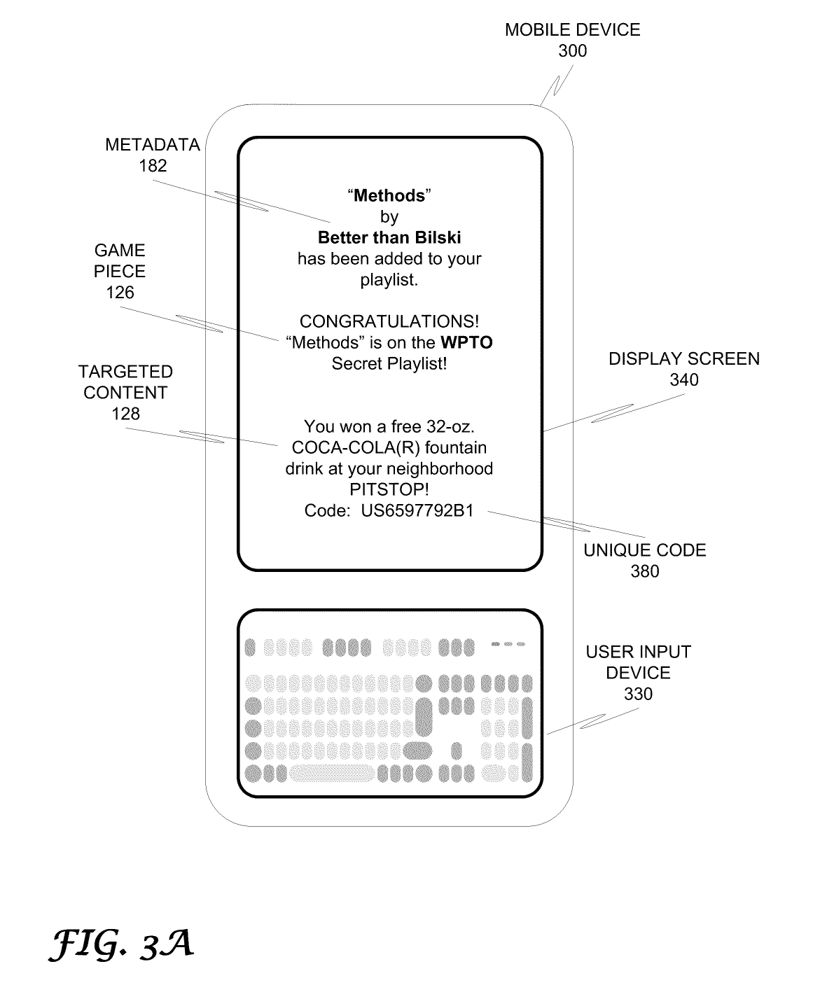

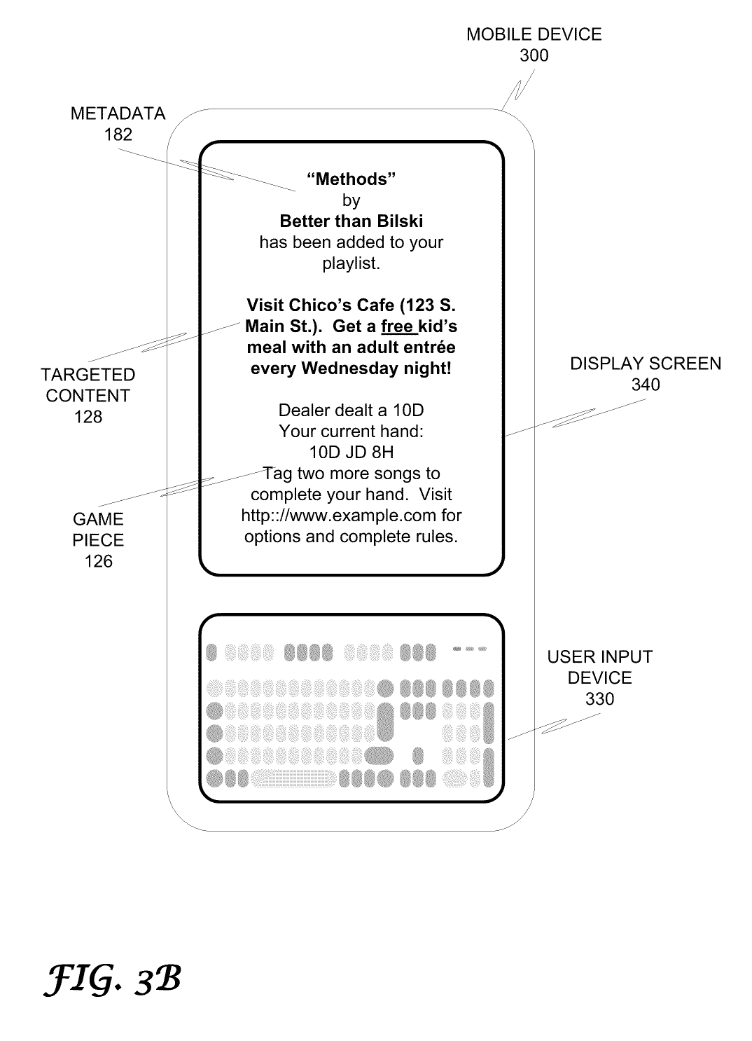

FIG. 3 is a front view of an embodiment of a mobile device 300 for use with a PDN 100 (FIG. 1). Mobile device 300 is an exemplary embodiment of a messaging device 120. Mobile device 300 may include a user input device 330 and a display screen 340. In this exemplary embodiment, the user has heard the song “Exhasution” by “LG and the Quantas” on radio station WPTO, and has sent a PRM with the content “WPTO.” This user has selected Secret Playlist as her default game. Game piece 126 informs her that “Exhaustion” is not on the secret playlist. If user 110 had indicated, for example, a preference for chocolate in her demographic data, targeted content 128 may advertise HERSHEY®-brand chocolates at a local convenience store.

FIG. 3A is a second front view of an embodiment of a mobile device 300 for use with a PDN 100. In this case, user 110 has tagged “Methods” by “Better than Bilski” for her playlist, which is on the WPTO Secret Playlist. Because user 110 selected a song on the Secret Playlist, she instantly wins a prize, in this case a free COCA-COLA® drink at a PITSTOP store. Because the prize is also useful as targeted content 128, it is placed after game piece 126. A unique code 380 is displayed, which may be used to permit a one-time redemption of the prize. In some cases, once the unique code 380 has been redeemed once, it will become invalid. In an alternative, unique code 380 may not be displayed. Instead, user 110 may be informed of the prize and instructed to logon to game server 176 to redeem. When user 110 logs on to game server 176, she may be permitted to print a coupon to redeem her prize, which may include a unique code 380, a bar code, or other useful identifying information. This encourages user 110 to interact with user interface 160, which may provide additional advertising opportunities.

FIG. 3B is a third front view of an embodiment of a mobile device 300 for use with a PDN 100 (FIG. 1). In this example, user 110 has selected Five-Card Draw as his default game. By tagging “Methods” by “Better than Bilski,” user 110 will receive targeted content 128 and has drawn a card, in this case 10D, or the 10 of diamonds. This is added to the cards already in his hand, the Jack of diamonds and the 8 of hearts. User 110 now needs to draw two additional cards to complete his hand, which he can do by tagging two more songs. In some embodiments, user 110 may also be able to complete his hand by interacting with user interface 160 and simply requesting cards, which will allow him to view additional advertising. Once user 110 has completed his hand, he may be able to use user interface 160 to discard, for example, up to three cards and draw replacement cards to try for a better hand.

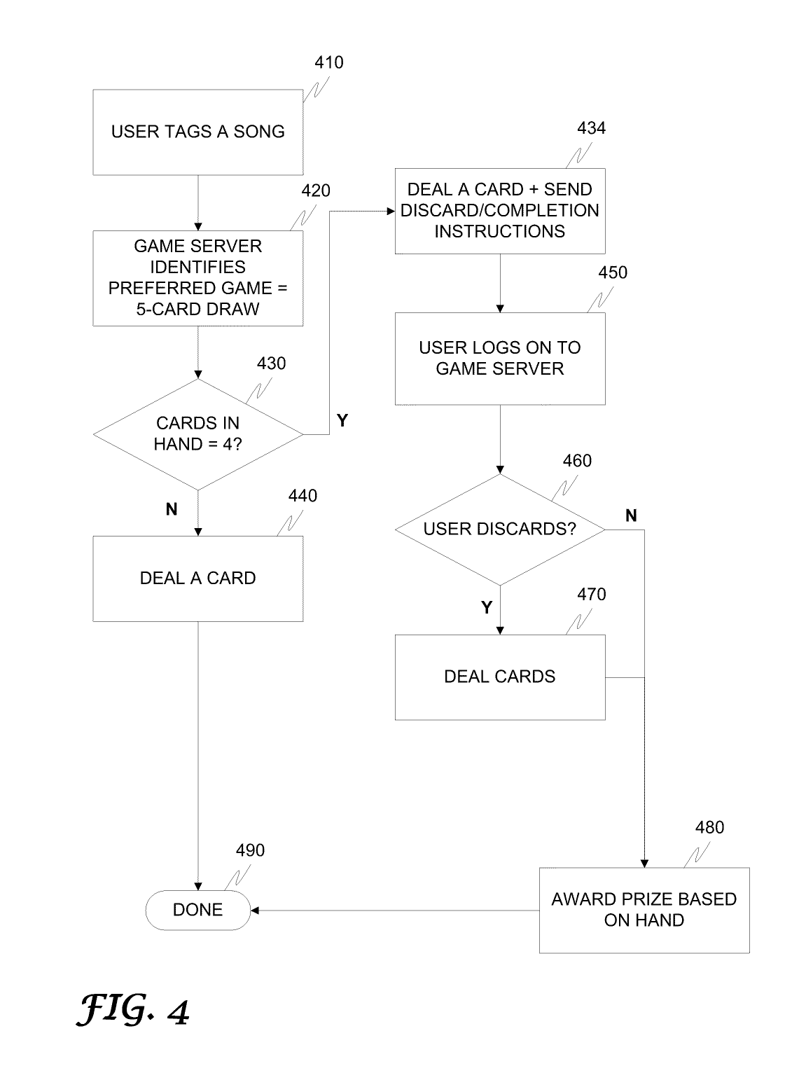

FIG. 4 is a flow chart showing operation of an exemplary embodiment of a Five-Card Draw game. According to this embodiment, at 410 a user tags a song. At 420, the game server identifies the user's preferred game as five-card-draw. At 430, the game server checks to see if the user has previously received four cards. If not, then at 440 the game server deals a new card and the process is complete at 490. If the user has four cards in his hand at 430, then he needs only one more card to complete his hand. In this case, at 434 the game server deals a card and also attaches discard and draw instructions. When the user logs on to game server at 450, he may elect to discard at 460. If he does, then at 470, the game engine deals additional cards to complete the hand. Once the hand is complete, at 480 the game server awards a prize, the value of which may be inversely proportional to the probability of the hand, and the process is complete at 490.

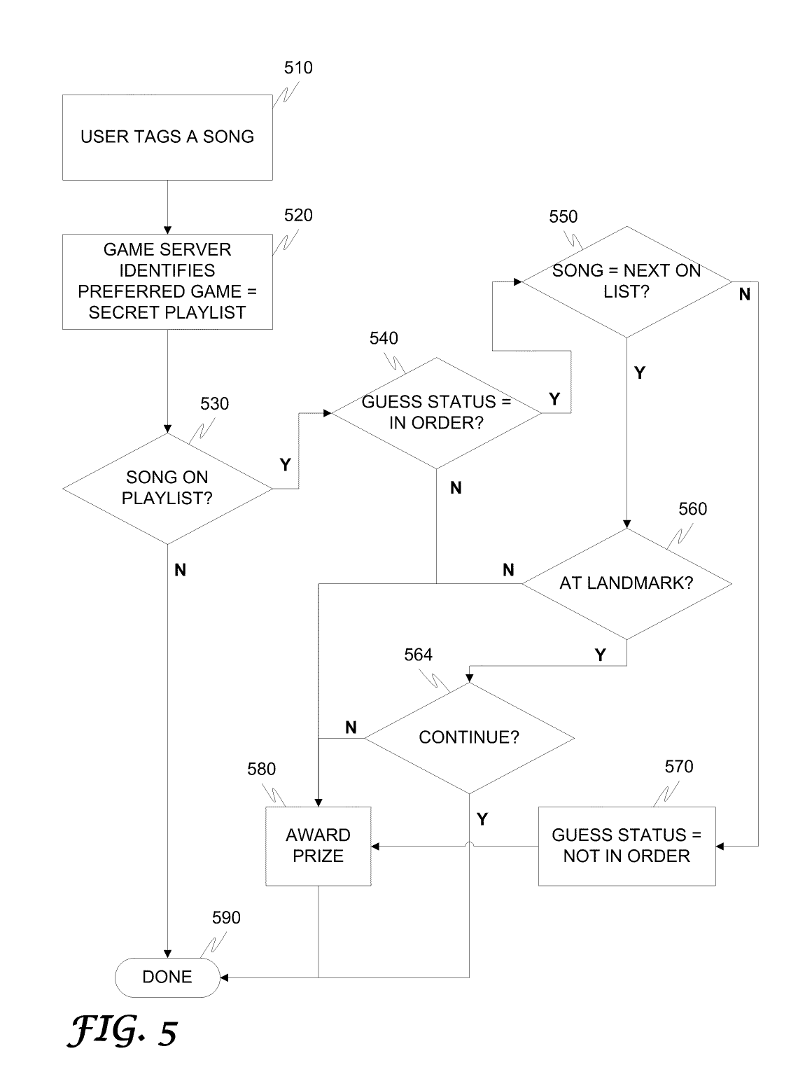

FIG. 5 is a flow chart showing operation of an exemplary embodiment of a Secret Playlist game. This example further includes a “push your luck” component for tagging songs in order. The object is to tag songs on the secret playlist in a certain order. For example, the secret playlist may contain songs A, B, and C. If the user tags Z, K, A, M, P, T, B, H, L, F, C, then she has tagged the secret playlist songs in the right order, even though she has tagged other songs, not on the list, in between. At 510, the user tags a song, and at 520 the game server identifies Secret Playlist as her preferred game. At 530, the game server checks to see if the song is on the secret playlist. If it is not, the user does not win, and the process completes at 590. Note that in this case, there is no change to the status of a flag that indicates whether the user is moving along the secret playlist in order. If the song is on the secret playlist, then at 540 the game server checks to see if the user's guesses are in order. If the guesses are out of order, then at 580, the game server awards a prize (either for tagging simply tagging a song on the secret playlist, or for tagging a certain number of songs on the playlist, regardless of order). If the user's guesses are in order, then at 550 the game server checks to see if the tagged song is the next on the list. If it is not, then the user's status is changed to “not in order” (indicating she has missed the order), and she is awarded a prize. If the tagged song is the next on the list, then at 560, the game server checks to see if the user has reached a “landmark” point. For example, landmarks may be at tagging 3, 6, and 10 songs in the correct order. Each landmark awards an increasingly valuable prize, but if the user elects to “push her luck” and aim for the next landmark, she will forfeit her prize if she tags a song out of order. So at 564, the game server informs the user that she has reached a landmark, informs her of the prize she has won, and asks her if she would like to continue. If the user elects to continue, she receives no immediate prize, so the process completes at 590. If she elects not to continue, then at 580, she is awarded the prize for the landmark she achieved and the process completes at 590.

While the subject of this specification has been described in connection with one or more exemplary embodiments, it is not intended to limit the claims to the particular forms set forth. On the contrary, the appended claims are intended to cover such alternatives, modifications and equivalents as may be included within their spirit and scope.

What is claimed is:

1. A product distribution network for providing targeted content, the product distribution network comprising:
a game server comprising:
a processor;
a storage medium communicatively coupled to the processor and configured to contain account data for users, the account data including demographic data about the users, the storage medium further configured to contain a targeted content database, the database including advertiser-selected criteria to correlate the targeted content to the demographic data;
a messaging interface communicatively coupled to the processor; and
a network interface communicatively coupled to the processor;
a data network communicatively coupled to the network interface of the game server, the data network comprising:
metadata received from a metadata provider; and
streaming media sent to a user interface; and
a messaging network communicatively coupled to the messaging interface, the messaging network configured to deliver product request messages to the game server and to receive response messages from the game server;
the game server being programmed to provide a game to a user of the product distribution network, wherein the programming includes instructions to:
receive a product request message from the user;
generate a game piece in response to the product request message; and
provide a response message to the user, the response message including a notification of a result of generating the game piece.

2. The product distribution network of claim 1 wherein the response message includes the game piece in an electronic and human-readable format.

3. The product distribution network of claim 1 wherein the response message includes targeted content selected from the content database based on demographic data about the user.

4. The product distribution network of claim 3 wherein the product request message identifies a song.

5. The product distribution network of claim 4 wherein the game includes a secret playlist and wherein a winning status is generated when the song identified matches an entry on the secret playlist.

6. The product distribution network of claim 3 wherein the game is a five card draw game, and wherein the game piece represents a playing card.

7. The product distribution network of claim 6 wherein
a winning status is generated when the user accumulates a winning hand selected from the group consisting of no pair high card, one pair, two pair, three of a kind, straight, flush, full house, four of a kind, straight flush, royal flush; and
the targeted content includes a prize with a value inversely proportional to the odds of receiving the winning hand.

8. The product distribution network 1 wherein the game is a lotto game, and wherein the game piece represents a lottery number.

9. A method of providing targeted content over a product distribution network, the method comprising the steps of:
providing a product distribution network over which a user may send product request messages and receive response messages;
providing a registration medium on which the user may register an account, including demographic data, the demographic data characterizing the user as a member of the subgroup;
providing to the user rules for a game, wherein participating in the game includes the user sending a product request message;
receiving a product request message from the user;
generating a game piece for the user in response to the product request message, the game piece changing the user's status in the game;
formatting the game piece into a user-readable format that informs the user of the user's change of status in the game;
sending a response message to the user, the response message including the game piece in a user-readable format informing the user of the user's change of status in the game.

10. The method of claim 9 wherein the response message further includes a metadata field and targeted content relevant to the subgroup.

11. The method of claim 10 wherein the metadata field identifies a song.

12. The method of claim 11 wherein the game includes a secret playlist, a further comprising the step of awarding the user a prize if the product request message requests information about a song on the secret playlist.

13. The method of claim 9 wherein the game is a five card draw game, and wherein the game piece represents a playing card.

14. The method of claim 9 wherein the game is a lotto game and wherein the game piece is a lottery number.

15. The method of claim 9 further comprising the step of awarding a prize to the user upon the occurrence of a winning condition.

16. The method of claim 15 wherein awarding the prize includes awarding points that the user may trade for a desired prize.

17. The method of claim 15 wherein the prize is selected to relate to the user's demographic data.

18. A game server suitable for use in a product distribution network, the game server comprising:
a processor;
a messaging interface communicatively coupled to the processor;
a network interface communicatively coupled to the processor; and
a storage medium communicatively coupled to the processor, the storage medium containing software instructions that, when executed, instruct the game server to:
receive a product request message on the messaging interface, the product request message including a time stamp, a station identifier, and identification of a user;
send the time stamp and station identifier to the network interface;
receive on the network interface metadata identifying a song;
format the metadata into a human readable format;
determine a preferred game for the user;
create a game piece for the user;
create a response message, the response message including the metadata in human readable format and the game piece; and
send the response message to the messaging interface.

19. The game server of 18 wherein:
the storage medium further includes instructions to:
read demographic data about the user from a user account;
locate in a database advertiser content relevant to the demographic data; and
create targeted content based on the advertiser content; and
wherein the response message further includes the targeted content.

20. The game server of claim 18 wherein the storage medium further comprises instructions to:
receive an advertising request on the network interface, the advertising request including a message field and one or more preferred demographic fields;
create an advertiser content record including the message field and preferred demographic fields;
match the user to the preferred demographic fields;
create a targeted content field including the message field; and
create the response message, wherein the response message further includes the targeted content field.

21. The game server of claim 20 wherein matching the user to the preferred demographic fields includes using a Boolean AND operation.

22. The game server of claim 20 wherein matching the user to the preferred demographic fields includes using a weighted analysis.

23. A game server suitable for use in a product distribution network, the game server comprising:
a processor;
a messaging interface communicatively coupled to the processor;
a network interface communicatively coupled to the processor; and
a storage medium communicatively coupled to the processor, the storage medium containing software instructions that, when executed, instruct the game server to:
provide an advertiser interface accessible by an advertiser, the advertising interface configured to:
receive an advertising message from the advertiser; and
receive preferred demographic data selectable by the advertiser to characterize a subgroup of a population likely to respond to the advertising message;
create an advertisement record comprising the
provide a metadata engine, the metadata engine configured to:
receive a product request message on the messaging interface, the product request message comprising a radio station identifier and time stamp;
send a metadata request on the network interface, the request message including the radio station identifier and time stamp;
receive metadata on the network interface, the metadata identifying a song that played on a radio station identified by the radio station identifier at a time identified by the time stamp;
provide a comparison engine, the comparison engine configured to:
compare demographic data characterizing the user to the preferred demographic data to determine that the user is a suitable target for the advertising message;
provide a game engine, the game engine configured to:
select a game for the user;
generate a game piece for the user, the game piece changing the user's status in the game;
generate a response message, the response message comprising the metadata identifying the song, the advertising message, and the game piece; and
provide a user interface engine accessible by a user, the user interface engine configured to:
permit the user to perform additional functions related to the game; and
add the song to a list of songs identified by the user.

24. The game server of 23 wherein the game is selected from the group consisting of a secret playlist, five-card draw, and lotto.

25. The game server of 23 wherein comparing demographic data comprises using a Boolean AND operation.

26. The game server of 23 wherein comparing demographic data comprises:
receiving a weight factor for each of a plurality of preferred demographic fields;
selecting fields in the demographic data characterizing the user that match at least some of the plurality of preferred demographic field; and
assigning the user a score by adding, for each selected field, the weight factor for the corresponding preferred demographic field.
